(19) United States
(12) Patent Application Publication
(10) Pub. No.: US 2020/0211552 A1
(43) Pub. Date: Jul. 2, 2020

(54) VOICE INTERACTION CONTROL METHOD AND APPARATUS

(71) Applicant: Baidu Online Network Technology (Beijing) Co., Ltd., Beijing (CN)

(72) Inventor: Yuning YANG, Beijing (CN)

(73) Assignee: Baidu Online Network Technology (Beijing) Co., Ltd., Beijing (CN)

(21) Appl. No.: 16/698,651

(22) Filed: Nov. 27, 2019

(30) Foreign Application Priority Data
Jan. 2, 2019 (CN) 201910002553.3

(51) Int. Cl. G10L 15/22; G10L 25/63

(52) U.S. Cl. CPC G10L 15/22; G10L 2015/225; G10L 2015/223; G10L 25/63

(57) ABSTRACT

A voice interaction control method and apparatus is provided. The method includes: identifying a voice signal received by a voice interaction device, to obtain a voice interaction requirement; determining that the voice interaction requirement is included in admission requirements learned in advance; and responding to the voice interaction requirement. The embodiments can meet the natural experience requirement of a user, learn a real requirement of the user in a use process by the user, and correct a wrongly identified requirement.

### CROSS-REFERENCE TO RELATED APPLICATION

This application claims priority to Chinese Patent Application No. 201910002553.3, filed on Jan. 2, 2019, which is hereby incorporated by reference in its entirety.

### TECHNICAL FIELD

The technical field relates to voice interactions, and particularly to a method and voice interaction control apparatus.

### BACKGROUND

Under a full-duplex interaction scene, a device is typically in a sound reception state. Various sounds will be recorded in a sound reception process, and excessive disturbances will be caused when all the sounds cause a response. If a user wants to change the response of the device, the user needs to actively issue a command to stop the response.

For example, after ‘Xiaodu, xiaodu, play a song’ is said, the device starts to play a song. If another function is needed, the user should say ‘pause playing’ to stop the device from playing. Then, the user says ‘what's the weather like today’, and the device gives an answer such as ‘it's sunny today; the highest temperature is xx, and the lowest temperature is xx’. Next, the user says ‘continue to play’, and the device continues to play the song. This experience of pausing and continuing the playback is unnatural and requires a user education.

### SUMMARY

A voice interaction control method and apparatus are provided according to the embodiments of the present disclosure, so as to solve one or more technical problems in the existing technology.

In a first aspect, a voice interaction control method is provided according to the embodiments of the present disclosure, the method includes:
identifying a voice signal received by a voice interaction device to obtain a voice interaction requirement;
determining that the voice interaction requirement is included in admission requirements learned in advance; and
responding to the voice interaction requirement.

In one embodiment, the method further includes:
receiving a negative feedback after responding to the voice interaction requirement; and deleting the voice interaction requirement from the admission requirements in response to the negative feedback.

In one embodiment, the receiving a negative feedback after responding to the voice interaction requirement; and deleting the voice interaction requirement from the admission requirements in response to the negative feedback, includes:
determining that the number of receiving the negative feedback exceeds a set threshold after responding to the voice interaction requirement; and deleting the voice interaction requirement from the admission requirements.

In one embodiment, the negative feedback includes a negative feedback expression and/or a negative feedback behavior.

In one embodiment, the method further includes at least one of:
taking a voice interaction requirement as an admission requirement, in response to a continuous detection of expressions approximate or identical to the voice interaction requirement within a set duration;
making statistics of responses of the voice interaction device to voice interaction requirements, and making statistics of feedbacks for the responses of the voice interaction device, to obtain an admission requirement;
taking a candidate requirement, to which the voice interaction device has responded, as an admission requirement.

In a second aspect, a voice interaction control apparatus is provided according to the embodiments of the present disclosure, the apparatus includes:
a requirement identifying module configured to identify a voice signal received by a voice interaction device, to obtain a voice interaction requirement;
an admission determining module configured to determine that the voice interaction requirement is included in admission requirements learned in advance; and
a responding module configured to respond to the voice interaction requirement.

In one embodiment, the apparatus further includes:
a requirement deleting module configured to receive a negative feedback after responding to the voice interaction requirement, and delete the voice interaction requirement from the admission requirements in response to the negative feedback.

In one embodiment, the requirement deleting module is further configured to determine that the number of receiving the negative feedback exceeds a set threshold after responding to the voice interaction requirement, and delete the voice interaction requirements.

In one embodiment, the negative feedback includes a negative feedback expression and/or a negative feedback behavior.

In one embodiment, the apparatus further includes at least one of:
a first admission module configured to take a voice interaction requirement, in response to a continuous detection of expressions approximate or identical to the voice interaction requirement within a set duration;
a second admission module configured to make statistics of responses of the voice interaction device to voice interaction requirements, and make statistics of feedbacks for the responses of the voice interaction device, to obtain an admission requirement; and
a third admission module configured to take a candidate requirement, to which the voice interaction device has responded, as an admission requirement.

In a third aspect, a voice interaction control apparatus is provided according to the embodiments of the present disclosure, and the functions thereof can be realized by hardware or by executing corresponding software through the hardware. The hardware or the software includes one or more modules corresponding to the above functions.

In a possible embodiment, the structure of the apparatus includes a memory configured to store a program supporting the apparatus to perform the voice interaction control method, and a processor configured to execute the program stored in the memory. The apparatus may further include a communication interface configured to communicate with other device or a communication network.

In a fourth aspect, a computer readable storage medium is provided according to the embodiments of the present disclosure, which is configured to store computer software instructions for use by a voice interaction control apparatus, including a program involved in performing the voice interaction control method.

One of the above technical solutions has the following advantages or beneficial effects: the natural experience requirement of the user can be met, the real requirement of the user can be learned in the use process by the user, and the wrongly identified requirement can be corrected.

The above summary is for the purpose of description, and is not intended to be limiting in any way. In addition to the illustrative aspects, embodiments and features described above, further aspects, embodiments and features of the present disclosure will be readily apparent with reference to the drawings and the following detailed descriptions.

### BRIEF DESCRIPTION OF THE DRAWINGS

In the drawings, unless otherwise specified, the same reference numeral refers to the same or similar parts or elements throughout the drawings. These drawings are not necessarily drawn to scale. It should be understood that these drawings depict only some embodiments disclosed in accordance with the present disclosure and should not be considered as limitations to the scope of the present disclosure.

FIG. 1 illustrates a flowchart of a voice interaction control method according to an embodiment of the present disclosure.

FIG. 2 illustrates a flowchart of a voice interaction control method according to an embodiment of the present disclosure.

FIG. 3 illustrates a structural block diagram of a voice interaction control apparatus according to an embodiment of the present disclosure.

FIG. 4 illustrates a structural block diagram of a voice interaction control apparatus according to an embodiment of the present disclosure.

FIG. 5 illustrates a structural block diagram of a voice interaction control apparatus according to an embodiment of the present disclosure.

### DETAILED DESCRIPTION OF THE EMBODIMENTS

In the following, certain embodiments are briefly described. As will be recognized by persons skilled in the art, the described embodiments can be modified in a variety of different ways without departing from the spirit or scope of the present disclosure. Accordingly, the drawings and descriptions are regarded as illustrative in nature rather than restrictive.

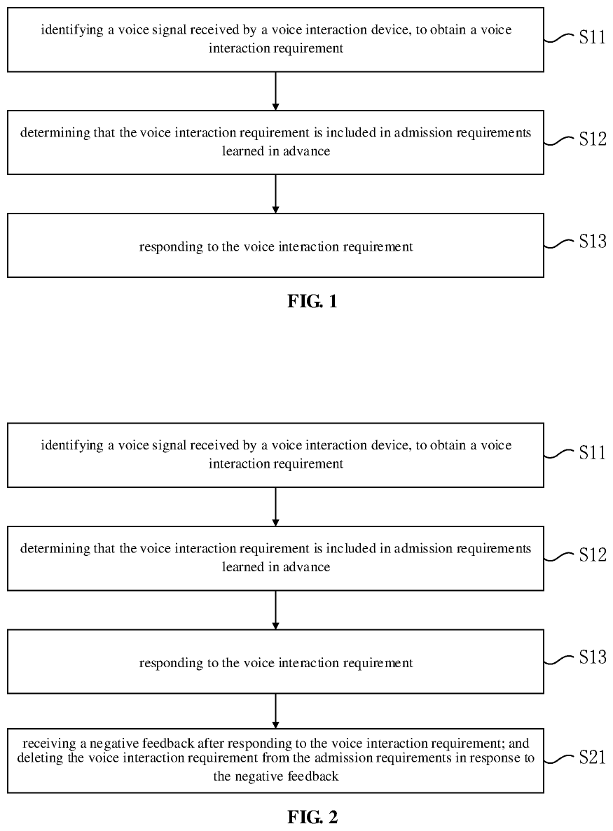

FIG. 1 illustrates a flowchart of a voice interaction control method according to an embodiment of the present disclosure. As illustrated in FIG. 1, the method may include:

S11: identifying a voice signal received by a voice interaction device, to obtain a voice interaction requirement;

S12: determining that the voice interaction requirement is included in admission requirements learned in advance;

S13: responding to the voice interaction requirement.

In the embodiments of the present disclosure, the voice interaction device may include various devices with a voice interaction function, such as a mobile phone, a notebook computer, a handheld computer, a smart speaker box, an audio and video player, etc.

After the voice interaction device is awakened, it enters a wake-up state and may begin to receive the sounds continuously within a reception duration. The reception duration may be set, according to the type of the voice interaction device and the requirement of the specific application scene. If the voice interaction device identifies a voice interaction requirement from the received voice signal within the reception duration, a corresponding operation may be performed according to the voice interaction requirement. The voice interaction device may identify the voice signal locally, or send the received voice signal to other device such as a voice identification server in the cloud for identification.

In addition, the admission requirement for the voice interaction device may be learned in advance. The learned admission requirement may be different for various voice interactive devices depending on their characteristics such as the environments and the user habits. The admission requirement for the voice interaction device can reflect the personalized characteristics of the voice interaction device.

In one example, if the user continuously utters identical or similar voices to the voice interaction device multiple times, a requirement corresponding to the identical or similar voices may be taken as an admission requirement. For example, if the user repeatedly utters the voices such as ‘hello’, ‘play a song’, ‘please turn off’ and ‘fast forward’ multiple times, the requirements corresponding to ‘hello’, ‘play a song’, ‘please turn off’ and ‘fast forward’ will be taken as the admission requirements.

In another example, it is assumed that a voice interaction device such as a speaker box is located in a studio, and the high-frequency or often-occurring voices usually occurring in the studio may include ‘play music XX’, ‘open video XX’ and ‘turn off’ for example.

Interferences may be caused if a response is made whenever any of these high-frequency voices is received. Thus, the learned admission requirements for this speaker box do not include those corresponding to ‘play music XX’, ‘open video XX’ and ‘turn off’.

In another example, it is assumed that a voice interaction device such as a speaker box is located in a hotel, and the high-frequency or often-occurring voices usually occurring in the hotel may include the greetings such as ‘hello’ and ‘welcome’. Interferences may be caused if a response is made whenever any of these high-frequency voices is received. Thus, the learned admission requirements for this speaker box do not include those corresponding to ‘hello’ and ‘welcome’.

In one embodiment, in the method, there are various modes to learn the admission requirements, and the examples are given as follows.

In mode 1, a voice interaction requirement is taken as an admission requirement, if expressions approximate or identical to the voice interaction requirement are continuously detected within a set duration.

For example, if it is detected multiple times within 10 s that the user repeatedly utters the voices including ‘play a song’ to the device continuously, playing music may be taken as an admission requirement for the device.

For another example, if it is detected multiple times within 10 s that the user continuously utters the voices similar to the requirement of playing music, including ‘play a song’, ‘play music’, ‘please play song XX’, etc., playing music may be taken as an admission requirement for the device.

In mode 2, an admission requirement is obtained by making statistics of responses of the voice interaction device to voice interaction requirements, and making statistics of feedbacks for the responses of the voice interaction device.

For example, a statistic analysis is made to determine voice interaction requirements responded by the device, and a voice interaction requirement without negative feedback, such as prohibiting a response thereto, from the user. Next, the voice interaction requirement without negative feedback is taken as an admission requirement.

In mode 3, a candidate requirement, to which the voice interaction device has responded, is taken as an admission requirement.

For example, 100 candidate requirements are preset. The device identifies the voices uttered by the user to obtain corresponding candidate requirements, and then responds to the candidate requirements. In addition, after the device responds, the user continues to interact with the device. In this case, a candidate requirement to which the device has responded may be taken as an admission requirement.

In the above mode 1, the set duration may be a reception duration of the voice interaction device. There are many modes to calculate the reception duration, and the examples are given as follows.

In example 1, the duration from the latest timing, at which the voice interaction requirement is identified, to the current timing is taken as the reception duration.

For example, if the latest timing at which the voice interaction requirement ‘what's the weather like today’ is identified is 10:00:00, and the current timing is 10:00:05, the reception duration is 5 s.

In example 2: the duration from the latest timing at which the voice signal is detected to the current timing is taken as the reception duration.

For example, if the latest timing at which the voice signal is detected is 8:00:00, and the current timing is 8:00:07, the reception duration is 7 s.

Next, it is determined whether the reception duration has timed out. For example, a duration threshold is set as 8 s, and if the reception duration is less than or equal to 8 s, it does not time out; otherwise it has timed out.

In a case where the reception duration does not time out, the voice interaction device can continuously receive the sounds, and identify the voice interaction requirement in the received voice signal.

In one embodiment, as illustrated in FIG. 2, the method further includes:

S21: receiving a negative feedback after responding to the voice interaction requirement; and deleting the voice interaction requirement from the admission requirements in response to the negative feedback.

In one embodiment, S21 includes:
determining that the number of receiving the negative feedback exceeds a set threshold after responding to the voice interaction requirement; and deleting the voice interaction requirement from the admission requirements.

In one embodiment, the negative feedback includes a negative feedback expression and/or a negative feedback behavior.

The negative feedback expression may include a voice uttered by the user after hearing a voice response from the voice interaction device, the voice indicating that the response is not needed. The negative feedback behavior may include a behavior made by the user after hearing a voice response from the voice interaction device, the behavior indicating that the response is not needed.

After a certain voice interaction requirement is responded to by the device, if negative feedbacks are received multiple times, it indicates that the user may not want the device to respond to the voice interaction requirement. If being included in the admission requirement learned in advance, the voice interaction requirement may be deleted therefrom in order that the device no longer responds to the voice interaction requirement subsequently. In this way, it is beneficial to correct the requirement of misidentified.

In one example, some default admission requirements may be preset for the voice interaction device. If no negative feedback is received subsequently, these default admission requirements will be reserved. A default admission requirement may be deleted if negative feedbacks are received for the default admission requirement multiple times. For example, the default admission requirement includes ‘play’, ‘what's the weather like’, etc. However, if most of the users prohibit the response to the above default requirement in a personalized manner, the default requirement will no longer be taken as the admission requirement.

The embodiments of the present disclosure can meet the natural experience requirement of the user, learn the real requirement of the user in the use process by the user, and correct the wrongly identified requirement. By personalizing the user experience, the self-iterative closed loop of the user experience is realized, and the data really takes effect.

In one application example, the admission modes are shown in Table 1, the prohibition modes are shown in Table 2, and the device may be in the same state after the prohibition and before the admission. The limit value of the reception duration is assumed as 8 s. If the characteristics of the learning signals are different within 8 seconds, the feedback modes may be different. After the initial admission and the second admission after learning, the response modes of the device may also be different. In Tables 1 and 2, Q indicates the content said by the user, and A indicates the response content of the device. ‘An=Refuse’ indicates that the device refuses to respond at the n-th time. The user's positive follow indicates that the user has uttered an approximate or identical expression, etc., which is a positive signal for admission. The user's negative follow indicates that the user has uttered a negative expression, etc., which is a negative signal for admission.

TABLE 1
Admission

| Learning | | Initial admission after | Second admission |
|---|---|---|---|
| signal | Feedback | learning | after learning |
| Expressed | ~playing music~ | ~playing music~ | ~playing music~ |
| approximately | Q1 = Hello | Q1 = Hello \| How do | Q1 = Hello \| How do |
| again after a | A1 = Refuse | you do? | you do? |
| short-term | Q2 = Xiaodu, xiaodu, how do you | A1 = I know you are | A1 = Hello \| How do |
| awakening | do? | talking to me this time | you do? |
| | A2 = Did you talk to me just now? | Hello \| How do you | |
| | How do you do? | do? | |
| | If the user follows positively, the | | |
| | requirement is admitted | | |
| | If the user follows negatively, the | | |
| | requirement is not admitted | | |
| Expressed | ~playing music~ | ~playing music~ | ~playing music~ |
| repeatedly | Q1 = Hello | Q1 = Hello | Q1 = Hello |
| after a | A1 = Refuse | A1 = I know you are | A1 = Hello |
| short-term | Q2 = Xiaodu, xiaodu, how do you | talking to me this time | |
| awakening | do? | Hello | |
| | A2 = I didn't think that you were | | |
| | talking to me just now | | |
| | How do you do? | | |
| | If the user follows positively, the | | |
| | requirement is admitted | | |
| | If the user follows negatively, the | | |
| | requirement is not admitted | | |
| Expressed | ~playing music~ | ~playing music~ | ~playing music~ |
| continuously, | Q1 = Hello | Q1 = Hello \| Hello, | Q1 = Hello \| Hello, |
| approximately | A1 = Refuse | Xiao Du | Xiao Du |
| and repeatedly | Q2 = How do you do? | A1 = I know you are | A1 = Hello |
| in a short term | A2 = Refuse | talking to me this time | |
| in case of | Q3 = Xiaodu, how do you do? | Hello | |
| unawakening | A3 = Did you talk to me just now? | | |
| | How do you do? | | |
| | If the user follows positively, the | | |
| | requirement is admitted | | |
| | If the user follows negatively, the | | |
| | requirement is not admitted | | |

Referring to Table 1, when the learning signal is ‘Expressed continuously, approximately and repeatedly in a short term in case of unawakening’, it is not necessary to learn from some meaningless expressions, such as ultra-short sentences and expressions having no specific meaning like ‘play’, ‘of’ and ‘for’.

TABLE 2
Prohibition

| Type | Learning signal | Prohibition |
|---|---|---|
| After | Negative Feedback for an | ~playing music~ |
| admission, | awakening-free behavior | (At this time, ‘Hello’ |
| the | | has been admitted) |
| negative | | Q 1 = Hello |
| feedback | | A1 = Hello |
| expression | | Q2 = Not talking to you \| Shut |
| of | | up \| How did he talk to |
| the user is | | himself |
| learned | | A2 = I heard wrong and |
| | | thought you talked to me just |
| | | now, so I will continue |
| | | to play it for you~ |
| | | Prohibited |
| After | The broadcast | ~playing music~ |
| admission, | is interrupted | (if ‘what's the weather like’ |
| the | at the beginning. If | has been admitted) |
| negative | the broadcast is not | Q1 = What's the weather like? |
| feedback | finished, it may not | A1 = weather~ |
| behavior | be considered as a | Q2 = Continue playing \| |
| of | negative feedback. For | Pause \| Shut up, Xiaodu |
| the user | example, it can be set | A2 = I heard wrong and |
| is | to finish broadcasting | thought you talked to me just |
| learned | within 3 seconds. | now, so I will continue |
| | Taking the weather | to play it for you~ |
| | as an example, just | Prohibited |
| | the first sentence | |
| | is said about the | |
| | weather, and the | |
| | broadcast is not finished. | |

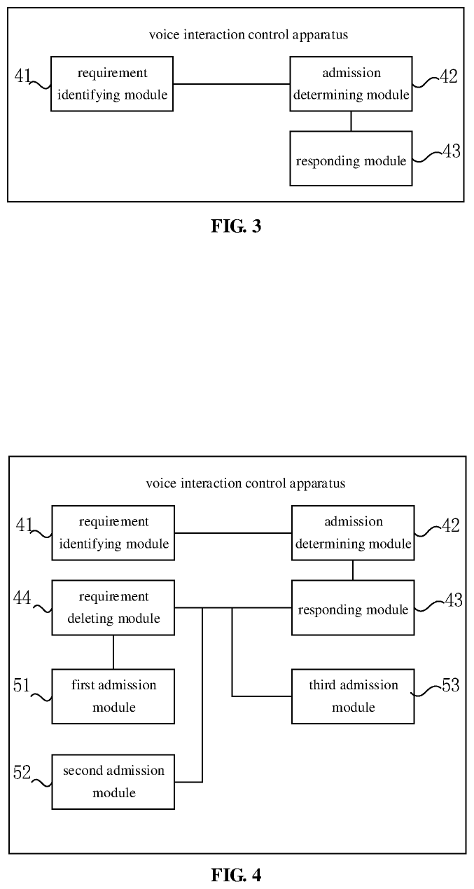

FIG. 3 illustrates a structural block diagram of a voice interaction control apparatus according to an embodiment of the present disclosure. As illustrated in FIG. 3, the voice interaction control apparatus may include:
a requirement identifying module 41 configured to identify a voice signal received by a voice interaction device, to obtain a voice interaction requirement;
an admission determining module 42 configured to determine that the voice interaction requirement is included in admission requirements learned in advance; and
a responding module 43 configured to respond to the voice interaction requirement.

In one embodiment, as illustrated in FIG. 4, the apparatus further includes:
a requirement deleting module 44 configured to receive a negative feedback after responding to the voice interaction requirement, and delete the voice interaction requirement from the admission requirements in response to the negative feedback.

In one embodiment, the requirement deleting module 44 is further configured to determine that the number of receiving the negative feedback exceeds a set threshold after responding to the voice interaction requirement, and delete the voice interaction requirement from the admission requirements.

In one embodiment, the negative feedback includes a negative feedback expression and/or a negative feedback behavior.

In one embodiment, the apparatus further includes at least one of:
a first admission module 51 configured to take a voice interaction requirement as an admission requirement, in response to a continuous detection of expressions approximate or identical to the voice interaction requirement within a set duration;
a second admission module 52 configured to make statistics of responses of the voice interaction device to voice interaction requirements, and make statistics of feedbacks for the responses of the voice interaction device, to obtain an admission requirement; and
a third admission module 53 configured to take a candidate requirement, to which the voice interaction device has responded, as an admission requirement.

The function of each of the modules in the apparatus according to the embodiments of the present disclosure can refer to corresponding descriptions in the above method, and will not be repeated here.

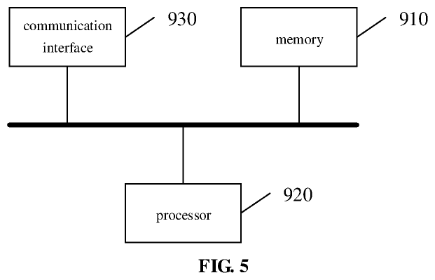

FIG. 5 illustrates a structural block diagram of a voice interaction control apparatus according to an embodiment of the present disclosure. As illustrated in FIG. 5, the apparatus includes: a memory 910 and a processor 920, wherein a computer program executable on the processor 920 is stored in the memory 910. When the processor 920 executes the computer program, the voice interaction control method in the above embodiment is implemented. There may be one or more memories 910 and one or more processors 920.

The apparatus further includes:
a communication interface 930 configured to communicate with an external device for a data interactive transmission.

The memory 910 may include a high-speed random access memory (RAM), and may also include a non-volatile memory, such as at least one disk memory.

If being implemented independently, the memory 910, the processor 920 and the communication interface 930 may be connected to each other through a bus and perform communications with each other. The bus may be an Industry Standard Architecture (ISA) bus, a Peripheral Component Interconnect (PCI) bus, an Extended Industry Standard Component (EISA) bus, or the like. The bus may be classified into an address bus, a data bus, a control bus, etc. For the convenience of representation, a single thick line is used in FIG. 5, but it does not mean that there is a single bus or one type of bus.

Alternatively, during implementation, if being integrated onto one chip, the memory 910, the processor 920 and the communication interface 930 can perform communications with each other through internal interfaces.

A computer readable storage medium is provided according to the embodiments of the present disclosure, the storage medium is configured for storing a computer program, which implements the method according to any one of the above embodiments when being executed by a processor.

Among the descriptions herein, a description referring to terms ‘one embodiment’, ‘some embodiments’, ‘example’, ‘specific example’, ‘some examples’, or the like means that specific features, structures, materials, or characteristics described in conjunction with the embodiment(s) or example(s) are included in at least one embodiment or example of the present disclosure. Moreover, the specific features, structures, materials, or characteristics described may be incorporated in any one or more embodiments or examples in a suitable manner. In addition, persons skilled in the art may incorporate and combine different embodiments or examples described herein and the features thereof without a contradiction therebetween.

In addition, the terms ‘first’ and ‘second’ are used for descriptive purposes only and cannot be understood as indicating or implying a relative importance or implicitly pointing out the number of the technical features indicated. Thus, the features defined with ‘first’ and ‘second’ may explicitly or implicitly include at least one of the features. In the description of the present disclosure, ‘a (the) plurality of’ means ‘two or more’, unless otherwise specified explicitly.

Any process or method description in the flow chart or otherwise described herein may be understood to mean a module, a segment, or a part including codes of executable instructions of one or more steps for implementing a specific logical function or process, and the scope of preferred embodiments of the present disclosure includes additional implementations, wherein the functions may be performed without in a sequence illustrated or discussed, including being performed in a substantially simultaneous manner according to the functions involved or in a reverse sequence, which should be understood by skilled persons in the technical field to which the embodiments of the present disclosure belong.

At least one of the logics and the steps represented in the flow chart or otherwise described herein, for example, may be considered as a sequencing list of executable instructions for implementing logical functions, and may be embodied in any computer readable medium for being used by or in conjunction with an instruction execution system, an apparatus or a device (e.g., a computer-based system, a system including a processor, or any other system capable of fetching and executing instructions from the instruction execution system, the apparatus, or the device). Regarding this specification, the ‘computer readable medium’ may be any means that can contain, store, communicate, propagate, or transfer a program for being used by or in conjunction with the instruction execution system, the apparatus, or the device. More specific examples (non-exhaustive list) of the computer readable medium include an electrical connection portion (electronic device) having one or more wires, a portable computer enclosure (magnetic device), a random access memory (RAM), a read only memory (ROM), an erasable editable read only memory (EPROM or flash memory), an optical fiber device, and a portable read only memory (CDROM). In addition, the computer readable medium may even be paper or any other suitable medium on which the program is printed, because the program can be electronically obtained, for example, by optically scanning the paper or other medium, and editing, interpreting, or processing in other suitable ways if necessary, and then stored in a computer memory.

It should be understood that various parts of the present disclosure may be implemented by hardware, software, firmware, or combinations thereof. In the above embodiments, a plurality of steps or methods may be implemented by software or firmware stored in a memory and executed with a suitable instruction execution system. For example, if hardware is employed for implementation, like in another embodiment, the implementation may be made by any one or combinations of the following technologies known in the art: a discreet logic circuit having a logic gate circuit for implementing logic functions on data signals, an application specific integrated circuit having an appropriate combinational logic gate circuit, a programmable gate array (PGA), a field programmable gate array (FPGA), etc.

Persons of ordinary skill in the art can understand that all or part of the steps carried by the above method embodiments can be implemented by instructing relevant hardware through a program, wherein the program may be stored in a computer readable storage medium, and it includes one or combinations of the steps of the method embodiments when being executed.

In addition, the functional units in various embodiments of the present disclosure may be integrated into one processing module, or may be physically presented separately, or two or more units may be integrated into one module. The above integrated module may be implemented in the form of one of hardware and a software functional module. If the integrated module is implemented in the form of a software functional module and sold or used as an independent product, it may also be stored in a computer readable storage medium that may be a read only memory, a magnetic disk or an optical disk, etc.

Those described above are only embodiments of the present disclosure, but the protection scope of the present disclosure is not limited thereto. Within the technical scope revealed in the present disclosure, any skilled person familiar with the technical field can easily conceive of various changes or replacements thereof, which should be covered by the protection scope of the present disclosure. Therefore, the protection scope of the present disclosure should be subject to that of the accompanied claims.

What is claimed is:

1. A voice interaction control method, comprising:
identifying a voice signal received by a voice interaction device, to obtain a voice interaction requirement;
determining that the voice interaction requirement is included in admission requirements learned in advance; and
responding to the voice interaction requirement.

2. The voice interaction control method according to claim 1, further comprising:
receiving a negative feedback after responding to the voice interaction requirement; and
deleting the voice interaction requirement from the admission requirements in response to the negative feedback.

3. The voice interaction control method according to claim 2, wherein the receiving a negative feedback after responding to the voice interaction requirement; and deleting the voice interaction requirement from the admission requirements in response to the negative feedback, comprises:
determining that a number of receiving the negative feedback exceeds a set threshold after responding to the voice interaction requirement; and deleting the voice interaction requirement from the admission requirements.

4. The voice interaction control method according to claim 2, wherein the negative feedback comprises a negative feedback expression and/or a negative feedback behavior.

5. The voice interaction control method according to claim 1, further comprising at least one of:
taking a voice interaction requirement as an admission requirement, in response to a continuous detection of expressions approximate or identical to the voice interaction requirement within a set duration;
making statistics of responses of the voice interaction device to voice interaction requirements, and making statistics of feedbacks for the responses of the voice interaction device, to obtain an admission requirement;
taking a candidate requirement, to which the voice interaction device has responded, as an admission requirement.

6. A voice interaction control apparatus, comprising:
one or more processors; and
a storage device configured to store computer executable instructions, wherein
the computer executable instructions, when executed by the one or more processors, cause the one or more processors to:
identify a voice signal received by a voice interaction device, to obtain a voice interaction requirement;
determine that the voice interaction requirement is comprised in admission requirements learned in advance; and
respond to the voice interaction requirement.

7. The voice interaction control apparatus according to claim 6, wherein the computer executable instructions, when executed by the one or more processors, cause the one or more processors further to:
receive a negative feedback after responding to the voice interaction requirement; and delete the voice interaction requirement from the admission requirements in response to the negative feedback.

8. The voice interaction control apparatus according to claim 7, wherein the computer executable instructions, when executed by the one or more processors, cause the one or more processors further to:
determine that the number of receiving the negative feedback exceeds a set threshold after responding to the voice interaction requirement; and delete the voice interaction requirement from the admission requirements.

9. The voice interaction control apparatus according to claim 7, wherein the negative feedback comprises a negative feedback expression and/or a negative feedback behavior.

10. The voice interaction control apparatus according to claim 6, wherein the computer executable instructions, when executed by the one or more processors, cause the one or more processors further to execute at least one of the following steps:
taking a voice interaction requirement as an admission requirement, in response to a continuous detection of expressions approximate or identical to the voice interaction requirement within a set duration;
making statistics of responses of the voice interaction device to voice interaction requirements, and making statistics of feedbacks for the responses of the voice interaction device, to obtain an admission requirement; and
taking a candidate requirement, to which the voice interaction device has responded, as an admission requirement.

11. A non-transitory computer-readable storage medium comprising computer executable instructions stored thereon, wherein the executable instructions, when executed by a processor, causes the processor to:
identify a voice signal received by a voice interaction device, to obtain a voice interaction requirement;
determine that the voice interaction requirement is included in a plurality of admission requirements learned in advance; and
respond to the voice interaction requirement.
